(19) United States
(12) Patent Application Publication
(10) Pub. No.: US 2002/0047025 A1
(43) Pub. Date: Apr. 25, 2002

(54) Valve ball

(75) Inventor: Dany Ray, Juziers (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: VALOIS S.A.

(21) Appl. No.: 09/978,565

(22) Filed: Oct. 18, 2001

(30) Foreign Application Priority Data
Oct. 20, 2000 (FR) 00 13455

(51) Int. Cl. G01F 11/06

(52) U.S. Cl. 222/321.3; 137/511; 222/321.7

(57) ABSTRACT

A valve ball serving to come into leaktight contact against a valve seat so as to close off selectively a communication passageway for a fluid, said valve ball comprising a substantially spherical core and a covering surrounding said core, said covering defining a deformable surface suitable for adapting its shape to accommodate any surface imperfections of the valve seat.

The present invention relates to a valve ball serving to come into leaktight contact against a valve seat so as to close off selectively a communication passageway for a fluid. The invention also relates to a dispenser including such a valve ball.

### BACKGROUND OF THE INVENTION

It is common to use a ball as a moving valve member for closing off a communication passageway for a fluid. By resting on a suitable seat, e.g. a seat that is frustoconical in shape, the ball allows a fluid to flow through the communication passageway in one direction only. It is therefore essential for the ball to rest in leaktight manner on the frustoconical valve seat.

Conventionally, the ball is made of a hard material, e.g. steel. in addition, the valve seat is often made of a molded plastics material. As a result, if the valve seat is not exactly frustoconical, i.e. if it has surface unevenness, the ball does not rest in completely leaktight manner on its seat. Since the valve seat is made of a molded plastics material, it is difficult to ensure that its surface quality is free from imperfections, since surface quality can be affected by plastic creep such as sink marks.

### OBJECTS AND SUMMARY OF THE INVENTION

An object of the present invention is to remedy the above-mentioned drawbacks of the prior art by defining a valve ball that offers complete leaktightness on its seat.

Document DE 43 21 787 describes a valve ball serving to be integrated into an inlet or outlet valve of a metering pump. That valve ball is made of rubber. Unfortunately, it is not easy, technically, to manufacture balls that are exactly spherical when they are made of rubber.

The present invention proposes a solution to that drawback.

To this end, the present invention provides a valve ball serving to come into leaktight contact against a valve seat so as to close off selectively a communication passageway for a fluid, said valve ball comprising a substantially spherical core and a covering surrounding said core, said covering defining a deformable surface suitable for adapting its shape to accommodate any surface imperfections of the valve seat.

The term “deformable outside surface” is used to mean a surface that can adapt its shape by deforming resiliently against the surface of the valve member, said deformable surface returning to its original shape that is preferably exactly spherical. The deformation is therefore not permanent, but rather it is only temporary and lasts while the ball is pressed against the valve seat.

The thickness of the covering may, for example, be about 1/10th of the diameter of the core. In addition, it is advantageous for the relative density of the ball to be at least about 3 times the density of the fluid that is to pass through the valve.

In a practical embodiment, the core is made of steel, the covering being made of Teflon™ or of silicone. The ball is then in the form of a steel ball coated with a covering of Teflon™ or of silicone. The steel ball imparts suitable density to the ball, while the Teflon™ or silicone covering forms the deformable soft surface.

It is also possible with such a valve ball to color the material of the covering so as to obtain a colored ball. This is very difficult to achieve with a conventional steel ball.

It is also possible for a bacteriostatic agent to be included in or applied on the covering of the ball.

A preferred use for a such a valve ball is in a fluid dispenser, such as a manual pump that can be actuated by using a finger. For example, the ball may serve as a moving valve member for an inlet valve.

### BRIEF DESCRIPTION OF THE DRAWINGS

The invention is described more fully below with reference to the accompanying drawings which give an embodiment of the invention by way of non-limiting example.

In the drawings:

FIG. 1 is a vertical section view through a fluid dispenser of the invention; and

FIG. 2 is an enlarged diagrammatic view of a valve ball of the invention in abutment against a frustoconical valve seat.

### MORE DETAILED DESCRIPTION

The present invention is illustrated with reference to a fluid dispenser which is a manual pump that can be actuated by using a finger. Reference could equally well have been made to other devices that include ball valves. The present invention must not therefore be limited to a fluid dispenser, since it relates more generally to a valve ball as can be found in many types of device.

The pump is not described in detail because it is not critical for the present invention.

It can be said that the pump used to illustrate the present invention is of a somewhat special type, with a piston 1 and a differential piston 5 that are mounted to slide inside a pusher 6 which is provided with a dispensing orifice in the form of a nozzle 7. The piston 1 is defined by a body 20 which also defines an inlet valve seat 24 which is extended downwards by a communication passageway 23. Once the pump is mounted on the fluid receptacle, the communication passageway 23 dips into the receptacle either directly or via an extension in the form of a dip tube. The piston 1 formed by the body 20 is mounted to slide against a wall 2 formed on the inside of the pusher 6 so as to co-operate with said pusher and with the differential piston 5 to form a fluid chamber 3 that can be closed off selectively at its inlet by a ball 4 resting on the valve seat 24. The differential piston 5 is mounted to slide against another cylindrical wall 11 formed by the pusher 6, and it is urged towards the ball 4 by a spring 15 that abuts against the top wall of the piston 6. When the pusher 6 is pressed, the piston 1 rises up the wall 2, thereby reducing the volume of the chamber 3. In reaction to this, the differential piston 5 moves upwards along the wall 11 against the spring 15, until the differential piston 5 clears the outlet duct leading to the nozzle 7.

During the entire phase of pressurizing the fluid inside the chamber 3, the ball 4 is pressed against its frustoconical seat 24. It may be observed that the seat 24 has a frustoconical shape in order to make it easier for the spherical ball 4 to bear thereagainst in leaktight manner. This is a conventional shape, but other shapes may be considered for the valve seat.

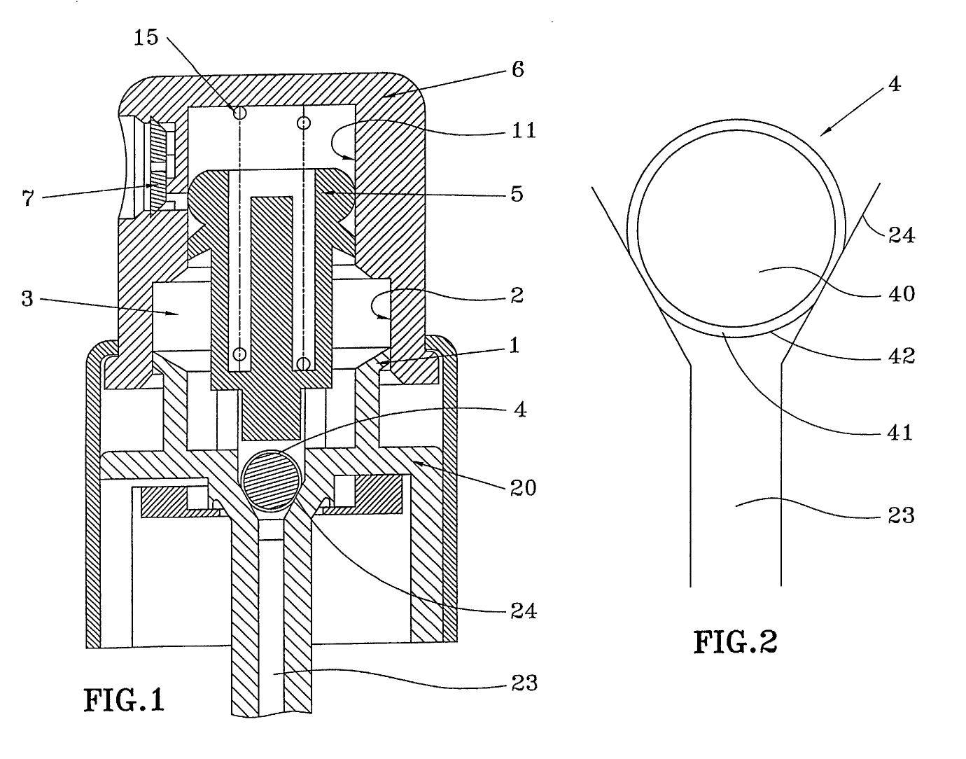

With reference more particularly to FIG. 2, which is an enlarged view of the inlet valve of FIG. 1, it is possible to see that the outside surface 42 of the valve ball 4 is slightly deformed where it is in contact with the frustoconical valve seat 24. In the invention, the outside surface of the valve ball is soft and deformable so that it can adapt its shape to accommodate any unevenness or imperfections in the surface of the frustoconical valve seat 24. To impart this characteristic of soft deformation to the outside surface of the ball 4, it is necessary to use a deformable soft material. For example, it is possible to use Teflon™ or silicone, these materials having good soft deformability characteristics.

The valve ball may be made entirely of a soft deformable material, but preferably, the ball may be made up of a hard spherical core 40 surrounded by a deformable soft covering 41 which defines the deformable surface 42. For example, the core may be made of steel. The covering must however have a certain thickness in order to adapt its shape to accommodate any surface imperfections of the valve seat by deforming. As a result, the thickness of the covering may, for example, be about 1/10th of the diameter of the core 40.

The use of a steel ball as a core 40 is particularly advantageous to impart to the valve ball relative density that is quite high so as to enable it to be pressed easily against its frustoconical seat 24. To ensure that the ball is positioned accurately and rapidly on its seat, the relative density of the ball must be at least about 3 times the density of the fluid that is to pass through the valve.

In addition, it is very easy to make colored balls merely by including a coloring agent in the covering of the ball. It is also possible to include a bacteriostatic agent in the covering, or to apply such an agent to the covering.

By means of the invention, it is possible to manufacture valves in which the seats do not need to have surfaces free from imperfections, because the deformable soft outside surface of the ball is suitable for compensating for any such surface imperfections.

1/ A valve ball serving to come into leaktight contact against a valve seat so as to close off selectively a communication passageway for a fluid, said valve ball comprising a substantially spherical core and a covering surrounding said core, said covering defining a deformable surface suitable for adapting its shape to accommodate any surface imperfections of the valve seat.

2/ A valve ball according to claim 1, in which the covering has a thickness of about one-tenth of the diameter of the core.

3/ A valve ball according to claim 1, in which the relative density of the ball is at least about 3 times the density of the fluid that is to pass through the valve.

4/ A valve ball according to claim 1, in which the core is made of steel, the covering being made of Teflon™ or of silicone.

5/ A valve ball according to claim 4, in which the covering includes a coloring agent.

6/ A valve ball according to claim 4, in which the covering includes a bacteriostatic agent.

7/ A fluid dispenser including a valve provided with a ball according to claim 1.

8/ A dispenser according to claim 7, in which the valve is an inlet valve.

9/ A dispenser according to claim 7, in which the dispenser is a manual pump that can be actuated by using a finger.
